(19) United States
(12) Patent Application Publication
(10) Pub. No.: US 2026/0342731 A1
(43) Pub. Date: Oct. 29, 2026

(54) TOPOLOGY AWARE CONGESTION CONTROL

(71) Applicant: Mellanox Technologies, Ltd., Yokneam (IL)

(72) Inventors: Yuval Shpigelman, Netanya (IL); Noam Katz, Ness Ziona (IL); Yuval Atias, Yokneam Moshava (IL); Omer Shabtai, Tel Aviv (IL)

(21) Appl. No.: 19/192,801

(22) Filed: Apr. 29, 2025

(51) Int. Cl. H04L 47/11; H04L 43/0864; H04L 47/24

(52) U.S. Cl. CPC H04L 47/11; H04L 43/0864; H04L 47/24

(57) ABSTRACT

Technologies for topology aware congestion control are described. A first network device includes a network interface to send one or more packets having a first priority and a management packet having a higher priority than the one or more packets at a first transmission rate over a network to a second network device, and packet processing circuitry that receives at least one acknowledgement of the one or more packets and an acknowledgement of the management packet. The packet processing circuitry determines, based on the received acknowledgements, a congestion delay between the first network device and the second network device, and adjusts, based on at least the congestion delay, the first transmission rate to a second transmission rate. The network interface sends one or more additional packets at the second transmission rate over the network to the second network device.

### TECHNICAL FIELD

At least one embodiment pertains to processing resources used for topology aware congestion control in packet communication networks. For example, at least one embodiment pertains to packet processing circuitry that can determine a congestion delay by sending packets having different priorities, and can adjust a transmission rate based on the congestion delay.

### BACKGROUND

The modern data center is undergoing a transformative evolution driven by the explosive growth of machine learning (ML) and artificial intelligence (AI) workloads. Traditional compute-and storage-centric architectures are giving way to highly optimized, AI-focused infrastructures designed to meet the unprecedented demands for parallelism, low latency, and massive throughput. At the heart of this evolution is the convergence of high-performance computing (HPC) and cloud-native scalability. Cutting-edge data centers now increasingly deploy GPU-accelerated compute nodes, custom ASICs, and purpose-built AI accelerators interconnected by ultra-low-latency, high-bandwidth fabrics.

The growth in data center sizes, driven by ML/AI's computational demands, poses challenges such as variations in data travel time between servers. These variations are caused by factors like the number of hops between servers and the length of cables, which can span hundreds of kilometers. Congestion management of packet traffic in communication systems is important as poor congestion control may significantly impact system performance. Congestion control (CC) algorithms are mechanisms used in computer networks to prevent or manage congestion by controlling the amount of data sent into the network. These algorithms ensure that network resources are used efficiently while preventing packet loss and excessive delays due to network congestion. A CC algorithm can use delays as congestion indications, such as round-trip time (RTT). Ensuring fairness in RTT-based congestion control is a major challenge in this context.

### BRIEF DESCRIPTION OF DRAWINGS

Various embodiments in accordance with the present disclosure will be described with reference to the drawings, in which:

FIG. 1 is a block diagram of a network device having topology-aware congestion control logic according to at least one embodiment.

FIG. 2A is a block diagram of RTT-based congestion control between two sender NICs sending packets to a receiver NIC via a switch according to at least one embodiment.

FIG. 2B is a block diagram of topology-aware congestion control between two sender NICs sending packets to a receiver NIC via a switch according to at least one embodiment.

FIG. 3 is a block diagram of a communication system with a sender network device 302 having a topology-aware CC unit and a receiver network device according to at least one embodiment.

FIG. 4 is a graph comparing an empty system RTT to relative delay according to at least one embodiment.

FIG. 5 is a flow diagram of a method for adjusting transmission rate based on congestion delays without topology delays according to at least one embodiment.

FIG. 6 is a flow diagram of a method for adjusting a first transmission rate to a second transmission rate using a congestion delay according to at least one embodiment.

FIG. 7A illustrates an example communication system with a controller with topology-aware congestion control logic according to at least one embodiment.

FIG. 7B illustrates a block diagram of an example communication system employing a topology-aware congestion control logic in a transmitter and a receiver according to at least one embodiment.

FIG. 8 illustrates an example computer system, including topology-aware congestion control logic, in accordance with at least some embodiments.

FIG. 9 is a block diagram of a computing system having two processing devices coupled to each other and multiple networks according to at least one embodiment.

FIG. 10 is a block diagram of a computing system having a central processing unit (CPU) and a graphics processing unit (GPU) in a single integrated circuit according to at least one embodiment.

FIG. 11 is a block diagram of a computing system having tensor core graphics processing units (GPUs) according to at least one embodiment.

### DETAILED DESCRIPTION

Technologies for topology aware congestion control are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, a CC algorithm can use delays as congestion indications, such as round-trip time (RTT). When using RTT as a congestion indication, “close senders” (i.e., senders that are closer in proximity to a receiver) will consistently get lower delay than “far senders” (i.e., senders that are farther away in proximity to the receiver). Thus, the close senders will experience less congestion, and will have higher rates than far senders. Previous solutions tried to prevent this unfair behavior by requiring every connection to knows its propagation delay to the destination. For example, the propagation delay could be determined using hop count, calculated from the TTL field in the IP header or using a hop count field in the GRH header in IB. This solution, however, can only work if all the network is layer 3 network. Also, if the higher latency comes from long-cable latency (not from multiple switches in the path), this solution is not working. Another solution tried to solve this problem by calculating a local minimum on the RTT measurements and using the RTT relative to this value. This solution works well when the buffers are large enough to have significant enough fluctuation of the RTT and the gap between the paths in the network is not too high (couple of microseconds). When shallow buffers are saturated or the gap between paths is larger (mostly because of long cables), this solution is not good enough.

Aspects and embodiments of the present disclosure address these problems and others by providing a CC algorithm that sends a special probe packet that explores the latency of a flow. This packet will be sent in both directions on special high-priority queues and measure the propagation delay between a sender and a receiver. The CC algorithm can subtract this value from every RTT measurement, obtaining the extra queuing delay only, which will be consistent to all senders and prevent the unfairness. Although this solution may need network configuration of the special priority, this solution does not need switch support to count the hops (from time-to-live (TTL)). This simpler solution does not require complicated calculations of the local minimum.

Aspects and embodiments of the present disclosure provide a simpler solution involving the use of special packets with a dedicated priority to measure the propagation delay of the network. Aspects and embodiments of the present disclosure provide a more accurate evaluation of the minimum RTT and improve congestion control. Aspects and embodiments of the present disclosure use special packets with a dedicated priority to measure the propagation delay of the network. These packets would be sent periodically with a special priority, bypassing regular queues to avoid congestion delays and accurately measure the minimum RTT. The special packets would help determine the propagation delay by traveling through the network with minimal interference from congestion. This would allow for a more accurate evaluation of the minimum RTT, which could then be used to adjust congestion control algorithms. Aspects and embodiments of the present disclosure can provide a congestion control algorithm that sends these special packets and uses the measured minimum RTT to adjust its calculations. Aspects and embodiments of the present disclosure provide a more accurate and resilient method for managing congestion in data centers.

Aspects and embodiments of the present disclosure can use management packets and measure RTT for each destination. The management packets can be part of the congestion control algorithm and would be sent with a special priority to measure the minimum RTT accurately, and measuring RTT for each destination individually. The algorithm can store the minimum RTT for each destination and use it to adjust congestion control calculations, ensuring accurate and fair bandwidth allocation. Aspects and embodiments of the present disclosure can provide improved accuracy in congestion control and better bandwidth management.

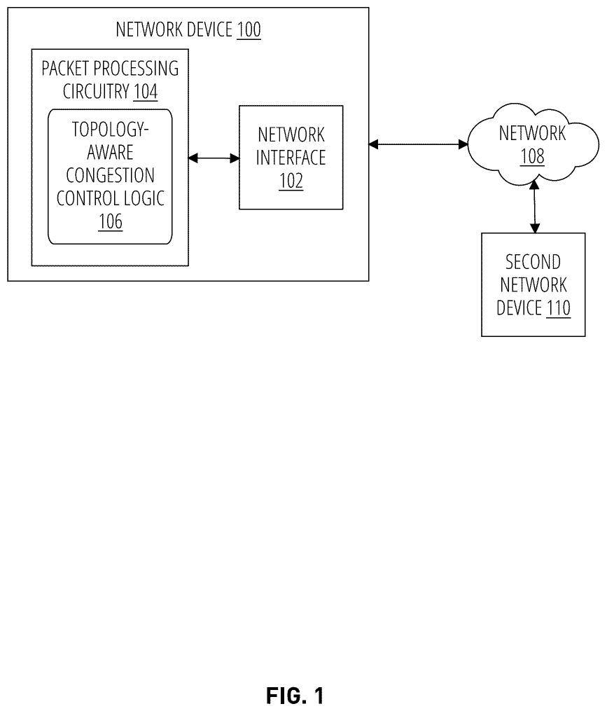

FIG. 1 is a block diagram of a network device 100 having topology-aware congestion control logic 106 according to at least one embodiment. The network device 100 includes a network interface 102 and packet processing circuitry 104. The network device 100 can be a network adapter, a network interface controller (NIC) (also referred to as network interface cards), a host channel adapter (HCA), or network circuitry implementing NIC or HCA functionality. The network device 100 is communicatively coupled to a network 108. The network 108 can include one or more switches or devices that span over small or large physical distances or cables. The network interface 102 can include circuits to facilitate sending and receiving packets to and from the network 108. The packet processing circuitry 104 is coupled to the network interface 102. The packet processing circuitry 104 can facilitate the processing of outgoing packets being sent by the network interface 102 and incoming packets being received by the network interface 102.

In at least one embodiment, the network interface 102 can be controlled to send one or more packets having a first priority and a management packet having a higher priority than the one or more packets at a first transmission rate over the network 108 to a second network device 110. The second network device 110 is also communicatively coupled to the network 108. The packet processing circuitry 104 can include topology-aware congestion control logic 106 that manages congestion control of data packets being sent by the network interface 102. The topology-aware congestion control logic 106 can receive at least one acknowledgement of the one or more packets and an acknowledgement of the management packet. The topology-aware congestion control logic 106 can determine, based on the received acknowledgements, a congestion delay between the network device 100 and the second network device 110. The topology-aware congestion control logic 106 can adjust, based on at least the congestion delay, the first transmission rate to a second transmission rate. In some cases, the second transmission rate is lower than the first transmission rate. In other cases, the second transmission rate is higher than the first transmission rate. The network interface 102 can be controlled to send one or more additional packets at the second transmission rate over the network 108 to the second network device 110.

In at least one embodiment, the network interface 102 can be controlled to send first data packets of a first flow of packets at a first transmission rate over the network 108 to the second network device 110. For example, the network interface 102 can send the first data packets to the second network device 110 via a switch of the network 108. The packet processing circuitry 104 can include topology-aware congestion control logic 106 that manages congestion control of data packets being sent by the network interface 102. The topology-aware congestion control logic 106 can cause the network interface 102 to send a first management packet over the network 108 to the second network device 110. The first management packet can have a higher priority than the first data packets. In at least one embodiment, the topology-aware congestion control logic 106 can generate the first management packet having the higher priority to be sent by the network interface 102. The topology-aware congestion control logic 106 can receive a first acknowledgement of the first management packet, and determine, using the first acknowledgement, a first delay representing a first physical delay between the network device 100 and the second network device 110. In at least one embodiment, the first delay is a RTT of the first management packet. In at least one embodiment, the first acknowledgement can be used to determine an RTT of the first management packet, representing the physical delay between the network device 100 and second network device 110. This physical delay can also be referred to as “empty system RTT,” since the first management packet is being sent with the highest priority (or at least higher priority than normal network data traffic). The topology-aware congestion control logic 106 can also determine, using one or more acknowledgements of one or more of the first data packets, a second delay. The second delay can represent a total delay including the first physical delay and a first congestion delay. The topology-aware congestion control logic 106 can determine a third delay using the first delay and the second delay. The third delay can represent only a first congestion delay between the network device 100 and the second network device 110. This third delay can be referred to as “empty system RTT plus buffer delay,” since the first data packets are being sent with a normal or lower priority than the first management packet. The topology-aware congestion control logic 106 can adjust, using the third delay, the first transmission rate to a second transmission rate. The topology-aware congestion control logic 106 can cause the network interface 102 to send second packets of the first flow of packets at the second transmission rate over the network 108 to the second network device 110 (e.g., via the one or more switches).

In at least one embodiment, the topology-aware congestion control logic 106 can determine the third delay by subtracting the first delay from the second delay. The first delay can be determined based on at least the acknowledgement of the management packet. The first delay can represent a first physical delay between the network device 100 and the second network device 110. The second delay can be determined based on the at least one acknowledgement of the one or more first packets. The second delay can represent a total delay, including the first physical delay and a congestion delay (also known as “queueing delay”) (i.e., congestion delay caused by congestion in the buffers of the one or more switches). As noted above, the first physical delay can be subtracted from the total delay to obtain the third delay, the third delay representing the congestion delay only.

In some embodiments, the one or more packets having the first priority is a management packet. That is, in one embodiment, the topology-aware congestion control logic 106 can send a first management packet with the first priority (i.e., normal or regular priority) at a first time, and a second management packet with a higher priority than the first priority at a second time. The network device 100 can send one or more data packets between the first time and the second time.

In at least one embodiment, the network interface 102 is controlled to send one or more packets having the first priority and another management packet having the higher priority at a third transmission rate over the network 108 to a third network device (not illustrated in FIG. 1). The packet processing circuitry 104 (or topology-aware congestion control logic 106) can receive at least one acknowledgment of the one or more packets and an acknowledgment of the other management packet. The packet processing circuitry 104 (or topology-aware congestion control logic 106) can determine, based on the at received acknowledgements, a congestion delay between the network device 100 and the third network device. The packet processing circuitry 104 (or topology-aware congestion control logic 106) can adjust, using the congestion delay between the network device 100 and the third network device, the third transmission rate to a fourth transmission rate. The network interface 102 is controlled to send one or more additional packet at the fourth transmission rate over the network to the third network device.

In at least one embodiment, the network interface 102 can send third data packets of a second flow of packets at a third transmission rate over the network 108 to a third network device. The packet processing circuitry 104 (or topology-aware congestion control logic 106) cause the network interface 102 to send a second management packet over the network 108 to the third network device, the second management packet having a higher priority than the third data packets. The packet processing circuitry 104 (or topology-aware congestion control logic 106) can receive a second acknowledgement of the second management packet. The packet processing circuitry 104 (or topology-aware congestion control logic 106) can determine, using the second acknowledgement, a fourth delay representing a second physical delay between the network device 100 and the third network device. The packet processing circuitry 104 (or topology-aware congestion control logic 106) can determine, using one or more acknowledgements of one or more of the third data packets, a fifth delay representing a total delay including the second physical delay and a second congestion delay. The packet processing circuitry 104 (or topology-aware congestion control logic 106) can determine a sixth delay using the fourth delay and the fifth delay, the sixth delay representing only a second congestion delay between the network device 100 and the third network device. The packet processing circuitry 104 (or topology-aware congestion control logic 106) can adjust, using the sixth delay, the third transmission rate to a fourth transmission rate. The packet processing circuitry 104 (or topology-aware congestion control logic 106) can cause the network interface 102 to send fourth data packets of the second flow of packets at the fourth transmission rate over the network 108 to the third network device.

In at least one embodiment, the network interface 102 can send a second management packet over the network 108 to the second network device 110. The packet processing circuitry 104 (or topology-aware congestion control logic 106) can receive at least one acknowledgement of the one more additional packets and an acknowledgement of the second management packet. The packet processing circuitry 104 (or topology-aware congestion control logic 106) can determine, based on the received acknowledgements, an updated congestion delay between the network device 100 and the second network device 110. The packet processing circuitry 104 (or topology-aware congestion control logic 106) can adjust, based on at least the updated congestion delay, the second transmission rate to a third transmission rate. The network interface 102 can send one or more additional packets at the third transmission rate over the network 108 to the second network device 110.

In at least one embodiment, the packet processing circuitry 104 (or topology-aware congestion control logic 106) can cause the network interface 102 to send a second management packet over the network 108 to the second network device 110, the second management packet having a higher priority than the first data packets. The packet processing circuitry 104 (or topology-aware congestion control logic 106) can receive a second acknowledgement of the second management packet. The packet processing circuitry 104 (or topology-aware congestion control logic 106) can determine, using the second acknowledgement, a fourth delay representing the first physical delay between the network device 100 and the second network device 110. The packet processing circuitry 104 (or topology-aware congestion control logic 106) can determine, using at least the first delay and the fourth delay, an average delay representing the first physical delay between the network device 100 and the second network device 110. The packet processing circuitry 104 (or topology-aware congestion control logic 106) can determine the third delay using the average delay instead of the first delay.

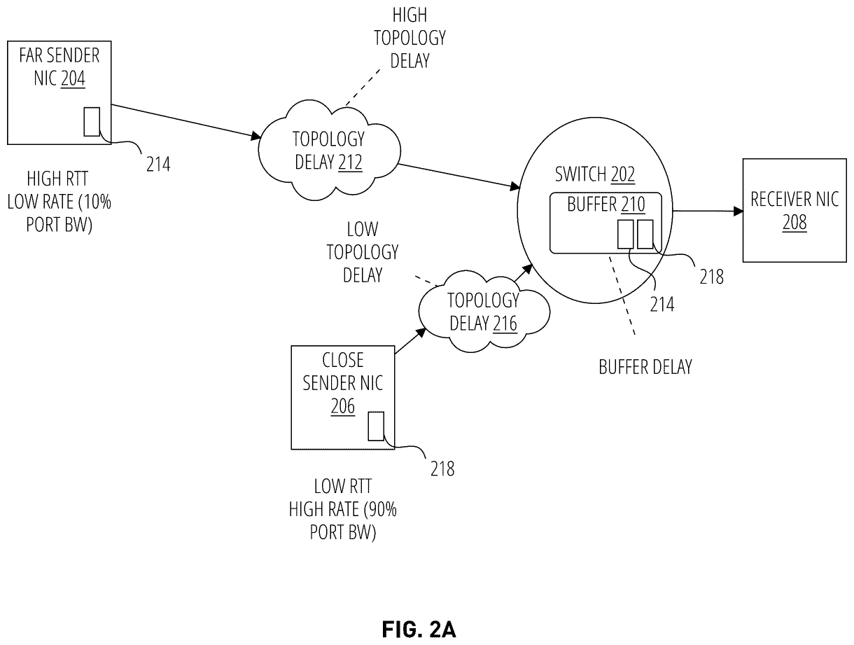

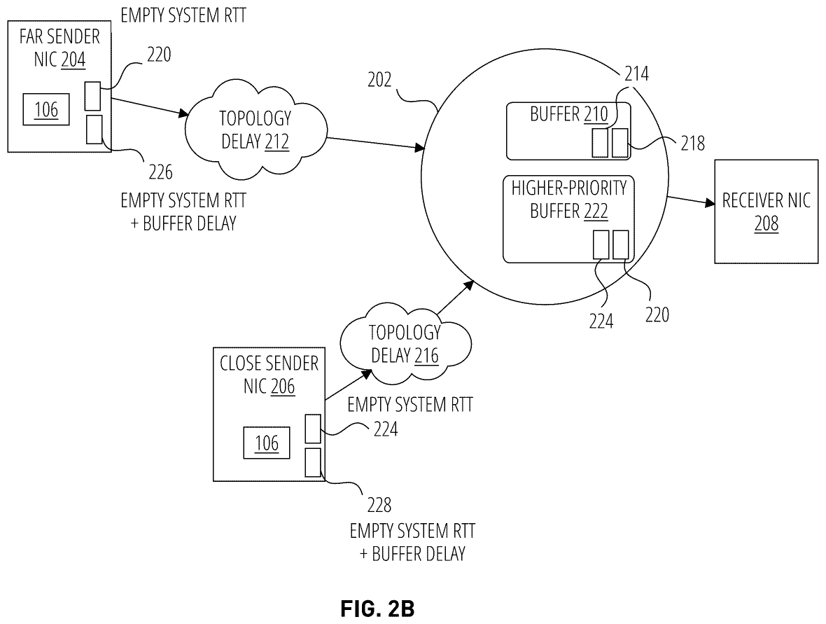

FIG. 2A is a block diagram of RTT-based congestion control between two sender NICs 204, 206, sending packets to a receiver NIC via a switch 202 according to at least one embodiment. In this embodiment, the CC algorithm used in the sender NICs is based on measuring RTT and evaluating congestion state accordingly. Although the following description refers to sender and receiver NICs and RTT, in other embodiments, other network devices and other delay measurements can be used.

As described above, when using RTT as a congestion indication, “close senders” (i.e., close sender NIC 206 that is closer in proximity to a receiver NIC 208 than a far sender NIC 204) will consistently get lower delay than “far senders” (i.e., far sender NIC 204 that is farther away in proximity to the receiver NIC 208). In particular, when the far sender NIC 204 sends a packet 214 to the receiver NIC 208 via the switch 202, the packet 214 traverses a network topology having a topology delay 212 and a buffer 210 of the switch 202 having a buffer delay. The topology delay 212 can be the result of physical distance, number of hops (i.e., switches), length of cable, etc. When the close sender NIC 206 sends a packet 218 to the receiver NIC 208 via the switch 202, the packet 218 traverse a network topology having a topology delay 216 that is less than the topology delay 212 and the buffer 210 having the buffer delay. When the receiver NIC 208 receives the packet 214, the receiver NIC 208 sends back an acknowledgement of the packet 214 to the far sender NIC 204. The far sender NIC 204 can determine an RTT corresponding to the packet 214. When the receiver NIC 208 receives the packet 218, the receiver NIC 208 sends back an acknowledgement of the packet 218 to the close sender NIC 206. The far sender NIC 204 can determine an RTT of the packet 214, and the close sender NIC 206 can determine an RTT of the packet 218. Since the topology delay 212 has a higher topology delay than the topology delay 216, the far sender NIC 204 determines a high RTT for the packet 214, and the packet 218 determines a low RTT for the packet 218. Since the RTTs measured by the close sender NIC 206 are lower than the RTTs measured by the far sender NIC 204, the close sender NIC 206 has a higher rate (e.g., 90% port bandwidth), and the far sender NIC 204 has a lower rate (e.g., 10% port bandwidth). Thus, the close sender NIC 206 will experience less congestion, and will have higher rates than far sender NIC 204.

As described above, previous solutions tried to prevent this unfair behavior by requiring every connection to knows its propagation delay to the destination. For example, the propagation delay could be determined using hop count, calculated from the TTL field in the IP header or using a hop count field in the global routing header (GRH) in InfiniBand® (IB). This solution, however, can only work if all the network is layer 3 network. Also, if the higher latency comes from long-cable latency (not from multiple switches in the path), this solution is not working. Another solution tried to solve this problem by calculating a local minimum on the RTT measurements and using the RTT relative to this value. This solution works well when the buffers are large enough to have significant enough fluctuation of the RTT and the gap between the paths in the network is not too high (couple of microseconds). When shallow buffers are saturated or the gap between paths is larger (mostly because of long cables), this solution is not good enough.

As such, the CC algorithm used in the sender NICs needs to distinguish between high RTT caused by buffer congestion delay (also referred to herein as “congestion delay”) and topology delay (also referred to herein as “empty system RTT”). Without this information, the close senders will consistently have lower RTT compared to far senders, leading to significant fairness issues. It should also be noted that the empty system RTT can vary for each CC flow within the NIC, necessitating per-flow measurements.

In at least one embodiment, the far sender NIC 204 (and the close sender NIC 206) can use the topology-aware congestion control logic 106 to determine a topology delay (“empty system RTT”) and a buffer congestion delay for topology-aware congestion control, as illustrated and described below with respect to FIG. 2B.

FIG. 2B is a block diagram of topology-aware congestion control between two sender NICs with topology-aware congestion control logic 106 sending packets to a receiver NIC 208 via the switch 202 according to at least one embodiment. In this embodiment, the CC algorithm used in the sender NICs is based on measuring RTT less the topology delay and evaluating congestion state accordingly. Although the following description refers to sender and receiver NICs and RTT, in other embodiments, other network devices and other delay measurements can be used.

In order to determine the topology delay 212 and the buffer congestion delay caused by the buffer 210, the far sender NIC 204 can send one or more packets 226 having a first priority and a management packet 220 having a higher priority than the one or more packets 226 at a first transmission rate to the receiver NIC 208 via the switch 202. When the switch 202 receives the management packet 220, the management packet 220 is identified as having a higher priority (or highest priority), and is stored in a higher-priority buffer 222 instead of the buffer 210. The switch 202 sends the management packet 220 to the receiver NIC 208 with a higher priority than data packets in the buffer 210. When the receiver NIC 208 receives the management packet 220, the receiver NIC 208 sends back an acknowledgement of the management packet 220 to the far sender NIC 204. The far sender NIC 204 can determine an empty system RTT of the management packet 220. After (or before) sending the management packet 220, the far sender NIC 204 can send one or more packets 226 at the first transmission rate to the receiver NIC 208 via the switch 202. When the switch 202 receives the one or more packets 226, they are stored in the buffer 210, since the one or more packets 226 have a lower priority than the management packet 220. The switch 202 sends the one or more packets packet 226 to the receiver NIC 208 with a normal or lower priority than the management packet 220. When the receiver NIC 208 receives the one or more packets packet 226, the receiver NIC 208 sends acknowledgements of the one or more packets packet 226 to the far sender NIC 204. The far sender NIC 204 can determine an RTT, including the empty system RTT and the congestion buffer delay. The topology-aware congestion control logic 106 can subtract out the empty system RTT from the measured RTTs. The empty system RTT represents a physical delay (or topology delay) between the far sender NIC 204 and the receiver NIC 208. By subtracting out the empty system RTT from each RTT measured for data packets, the congestion delay caused by the congestion in the buffer can be isolated and used for evaluating congestion state accordingly. The topology-aware congestion control logic 106 can adjust the first transmission rate to a second transmission rate for subsequent packets based on the congestion delay. The topology-aware congestion control logic 106 can normalize the RTT between senders by removing the empty system RTT, thus reacting upon real congestion. This results in fairness between senders, regardless of the sender's physical distance (or cable length).

Similarly, the topology-aware congestion control logic 106 of the close sender NIC 206 can send management packets with higher priorities to determine the topology delay 216 and the buffer congestion delay caused by the buffer 210. The close sender NIC 206 can send one or more packets 228 having a first priority and a management packet 224 having a higher priority than the one or more packets 228 at a third transmission rate to the receiver NIC 208 via the switch 202. When the switch 202 receives the management packet 224, the management packet 224 is identified as having a higher priority (or highest priority), and is stored in the higher-priority buffer 222 instead of the buffer 210. The switch 202 sends the management packet 224 to the receiver NIC 208 with a higher priority than data packets in the buffer 210. When the receiver NIC 208 receives the management packet 224, the receiver NIC 208 sends back an acknowledgement of the management packet 224 to the close sender NIC 206. The close sender NIC 206 can determine an empty system RTT of the management packet 224. After (or before) sending the management packet 224, the close sender NIC 206 can send one or more packets 228 at the third transmission rate to the receiver NIC 208 via the switch 202. When the switch 202 receives the one or more packets 226, they are stored in the buffer 210, since the one or more packets 228 have a lower priority than the management packet 224. The switch 202 sends the one or more packets packet 228 to the receiver NIC 208 with a normal or lower priority than the management packet 224. When the receiver NIC 208 receives the one or more packets packet 228, the receiver NIC 208 sends acknowledgements of the one or more packets packet 228 to the close sender NIC 206. The close sender NIC 206 can determine an RTT, including the empty system RTT and the congestion buffer delay. The topology-aware congestion control logic 106 can subtract out the empty system RTT from the measured RTTs. The empty system RTT represents a physical delay (or topology delay) between the close sender NIC 206 and the receiver NIC 208. By subtracting out the empty system RTT from each RTT measured for data packets, the congestion delay caused by the congestion in the buffer can be isolated and used for evaluating congestion state accordingly. The topology-aware congestion control logic 106 can adjust the third transmission rate to a fourth transmission rate for subsequent packets based on the congestion delay. The topology-aware congestion control logic 106 can normalize the RTT between senders by removing the empty system RTT, thus reacting upon real congestion. This results in fairness between senders, regardless of the sender's physical distance (or cable length).

In at least one embodiment, the topology-aware congestion control logic 106 can send a first management packet having a first priority and a second management packet having a higher priority than the first priority. The first management packet can traverse to the receiver NIC 208 via the buffer 210, whereas the second management packet can traverse to the receiver NIC 208 via the higher-priority buffer 222, isolating the congestion delay caused by the buffer 210 and the topology delay (i.e., physical delay) between the sender and receive NICs.

In at least one embodiment, the management packet 220 (or management packet 224) can be a special packet that is marked accordingly. This allows the topology-aware congestion control logic 106 (and the switch 202) to identify it and process it accordingly. The topology-aware congestion control logic 106 can normalize the RTTs by reducing them by the empty system RTT, such as a per-flow basis. This allows the topology-aware congestion control logic 106 to react to real congestion, regardless of the physical delay between sender and receive NICs. Normalizing the RTT results in guarantying fairness in between senders regardless of the node's physical delay caused by distance, length of cable, etc.

In other embodiments, the far sender NIC 204 can send packets to the receiver NIC 208 through more switches than the switch 202. Similarly, the close sender NIC 206 can send packets to the receiver NIC 208 through more switches than switch 202.

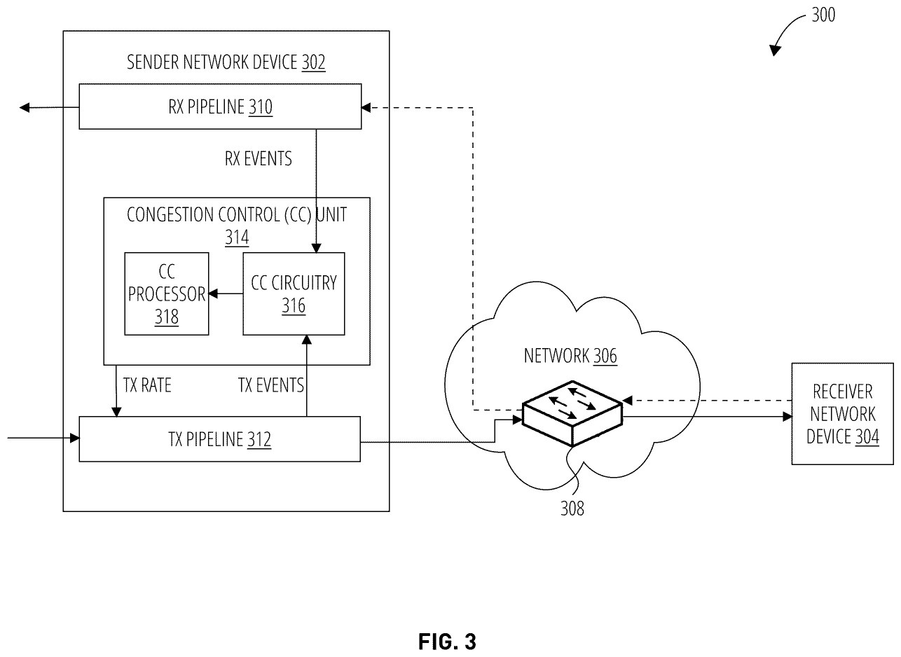

FIG. 3 is a block diagram of a communication system 300 with a sender network device 302 having a topology-aware CC unit 314 and a receiver network device 304 according to at least one embodiment. The topology-aware CC unit 314 can implement a CC algorithm. In general, CC algorithms change the transmission rate (also referred to as transmit rate or TX rate) of packets from a source that transmits packets (e.g., a network adapter in a source node), in response to congestion notifications that the source receives. Congestion notifications are typically added to a packet stream (either as a separate packet, or as an additional information on an existing packet). When the packets reach their destination (e.g., a network adapter in a destination node), the destination sends the congestion notifications back to the source, which may decrease the transmit rate in response to the notification (or increase the rate if no congestion notifications are received). The CC algorithms are typically flow-oriented, and the rate of each flow of packets is independently controlled, in response to congestion notifications pertaining to packets of the same flow.

In at least one embodiment, the CC algorithm is implemented as instructions executed by a processing device of the sender network device 302. In at least one embodiment, the CC algorithm is implemented using CC circuitry 316 and CC processor 318 of the topology-aware CC unit 314, coupled between a receive (RX) pipeline 310 and a transmit (TX) pipeline 312, as illustrated in FIG. 3. The CC processor 318 can be a dedicated congestion control programmable processor (“CC processor 318”, also referred to as “processor”) that is tightly coupled to the communication ports. The CC processor 318 can throttle (decrease or increase) the TX rate of packets, responsive to the network's traffic load. In embodiments, the CC circuitry 316 is configured to send, return and receive Round-Trip-Delay (RTT) Measurement packets, which may be useful for the setting of the TX rate. As described herein, the topology-aware CC unit 314 can generate and send management packets having higher priorities to measure an empty system RTT to normalize the RTT measurements.

The sender network device 302 (e.g., sender NIC) typically include one or more ingress ports, that receive packets from a network 306 and send the packets to an input queue; and one or more egress ports, that receive packets from an output queue and send the packets to the network 306. In the description hereinbelow, we will refer to the aggregation of the ingress ports and the input queue as RX pipeline 310 (or RX pipe), and to the aggregation of the output queue and the egress ports as TX pipeline 312 (or TX pipe).

In at least one embodiment, the CC circuitry 316 includes an events queue, which is configured to receive TX and RX notifications pertaining to sending and receiving packets, respectively, and to send the events notifications to the CC processor 318. The CC circuitry 316 typically receives TX notifications for each predefined burst of sent packets, and RX notifications for the following received packets: positive and negative acknowledgment (ACK and NACK) packets; congestion notification packets (packets that are sent back by a peer network adapter in response to the sent packets); and returned RTT measurement packets.

In some embodiments, to avoid congestions in the events queue, the CC circuitry 316 is configured to discard (drop) some of the events, responsive to the occupancy of the queue (this congestion is not to be confused with congestion in the network).

In some of the example embodiments below, references are made to Remote Direct Memory Access (RDMA) over Converged Ethernet (RoCE); however, the techniques disclosed herein are not limited to RoCE, and may be used in any suitable network configurations.

According to some embodiments, the event types that are stored in the event queue comprise:
1. TX—sending of a burst of packets;
2. CNP—receiving of a Congestion Notification Packet (CNP);
3. NACK—receiving of NACK;
4. ACK—receiving of ACK;
5. RTT—receiving a response packet to a Round-Trip-Delay (RTT) measurement packet (will be described below); and
6. Host injected events.

In some embodiments, events are represented in the events queue by entries that include an event-type field, a timestamp field, a serial-number field, a flow-identification field, a field representing the number of sent bytes for a Tx event, and fields for additional RTT-receipt-event time stamps.

In some embodiments, events queue includes, in addition to events that are generated by the Tx and Rx pipes, events that the Firmware generates, which may be defined by a user of the NIC and provide algorithm flexibility.

In some embodiments, the CC circuitry 316 includes an arbiter (e.g., round robin), which selects an event to be processed from the events queue, or a firmware event. In some embodiments, the number of event types may be larger than the number of event types that the CC circuitry 316 can handle, and a mapping may be employed, which maps more than one event type to the same “event class”.

In embodiments, the CC algorithms that the CC processor 318 runs includes a plurality of concurrent processes, wherein each process controls congestion in a single flow of packets. Each process is configured to receive events pertaining to the corresponding flow, update the rate (and, possibly, request RTT measurements), and then pause until the next event is received. To allow execution by a limited number of processors, each process is assigned a context in memory; a process may be paused by storing the context and resumed by reading the stored context (as the number of possible contexts may be large, contexts pertaining to flows that are not active are typically stored in a slower memory, and read by the processor when needed).

According to some embodiments, the CC processor 318 includes a plurality of independent processors, and events that the CC circuitry 316 sends to the CC processor 318 for processing are allocated to processors that are not busy. A processor that is assigned to handle an event reads the corresponding context, and then runs the process, possibly changing the transmit rate for the flow and/or requesting RTT measurements, and, lastly, stores the updated context, in preparation for the processing of the next event.

In some embodiments, reliable measurement of packet round-trip delay (RTT) is an important parameter for the CC algorithm. RTT measurement is typically done by calculating the time difference from the sending of a packet to the receiving a of corresponding ACK; however, such measurement technique is not accurate, because the ACK is initiated by the processor, and the RTT measurement will include the time it takes for the software to respond.

As described herein, some embodiments support RTT measurement packets, which are sent from a Sender Network Interface Controller (NIC) to a Receiver NIC, which returns the packet to the Sender NIC. The sender NIC adds a first timestamp to the sent packet; the receiver NIC adds a second timestamp to the packet when the packet is received, routes back the packet to the Sender-NIC, and adds a third timestamp when the packet is sent back. The Sender NIC can then, by observing the three time stamps (and the time in which the return packet arrives), accurately calculate the RTT, breaking it to segments, including time from sender-NIC to receiver-NIC, time within the receiver-NIC, time (of the return packet) from receiver-NIC to sender-NIC.

In at least one embodiment, the communication system 300 has an RoCE architecture with congestion mitigation. A sender network device 302 (e.g., a transmitting NIC) transmits packets over a network 306 to a receiver network device 304 (e.g., receiving NIC). (It should be noted that both the transmitting NIC and the receiving NICs are configured to both transmit and receive packets; the terms “transmitting” and “receiving” hereinabove refer to the direction in which congestion is mitigated.)

As described above, the sender network device 302 includes a TX pipeline 312, which queues and arbitrates packets that the sender network device 302 transmits and sends the packets to network 306. The network 306 include, according to the example embodiment illustrated in FIG. 3, a switch 308, which, when congested, marks packets the transmitting NIC sends with an Explicit Congestion indication (ECN). The receiver network device 304 sends return packets back to the sender network device 302, including packets that are used for congestion control (designated by dashed lines in FIG. 3), such as CNP packets, ACK/NACK packets, and RTT measurement packets. When the receiver network device 304 receives a packet with ECN indication, the receiver network device 304 sends a CNP packet back to the sender network device 302.

As illustrated, the sender network device 302 includes an RX pipeline 310, which receives incoming packets from the network 306, and a topology-aware CC unit 314.

The topology-aware CC unit 314 is configured to execute congestion control algorithms and mitigate congestion in the RoCE transmit path, including normalizing the RTTs by removing the corresponding topology delay. The topology-aware CC unit 314 includes the CC processor 318, which is configured to run congestion control algorithms, and a CC circuitry 316, which is configured to send congestion events to the CC processor 318.

In at least one embodiment, the CC circuitry 316 receives Tx events when TX pipeline 312 sends bursts of packets, and Rx events when RX pipeline 310 receives congestion control packets. (The received congestion control packets may include, for example, ACK and NACK that are received in response to transmitted packets, CNP packets that the receiving NIC generates in response to receiving ECN-marked packets, and RTT measurement packets.)

The CC circuitry 316 queues the events and sends at least some of the events to the CC processor 318 over a hardware-implemented direct point-to-point interface. In the present context, the term “direct point-to-point interface” means an interface that does not involve communication over a bus, an interrupt or any other operating system invocation. The CC processor 318 processes the events and runs congestion control algorithms to calculate the required transmission rate for further packets, and then informs the rates to TX pipeline 312 and, optionally, requests that the TX pipeline 312 send an RTT measurement packet.

In some embodiments, the CC processor 318 runs the congestion control algorithms separately for each flow of packets, and the transmission rate is determined separately for each flow.

In at least one embodiment, communication between the CC circuitry 316 and CC processor 318 does not involve operating system calls—the CC processor 318 signals that it is ready to process events (e.g., by asserting a dedicated signal) and then reads the event on an input bus that the CC circuitry 316 drives.

Thus, according to the example embodiment of FIG. 3, congestion events are queued in by dedicated circuitry, and submitted to a dedicated processor that runs congestion control algorithms, modifying the transmit rate accordingly. The overhead associated with running the algorithms is small, and flexibility to changing congestion control algorithms is preserved.

As would be appreciated, the configuration of RoCE architecture is an example configuration that is depicted purely for the sake of conceptual clarity. Other suitable configurations may be used in alternative embodiments. For example, instead of (or in addition to) RoCE, the architecture may be TCP and/or converged Non-Volatile-Memory (NVM) storage (e.g., hyper-converged NVM-f). Congestion events that CC circuitry 316 receives may be pre-sorted by additional hardware or software; the rate at which the TX pipeline 312 sends the packets may be jointly controlled by CC processor 318 and by other algorithms of sender network device 302.

In at least one embodiment, the sender network device 302 is a first network adapter including the RX pipeline 310, the TX pipeline 312, the CC circuitry 316, and the CC processor 318. The RX pipeline 310 is configured to receive packets from the network 306 and process the received packets. The network 306 includes at least one switch 308 between the first network adapter and the receiver network device 304 (i.e., a second network adapter). The TX pipeline 312 is configured to transmit packets to the network 306. The CC circuitry 316 is coupled to the RX pipeline 310 and the TX pipeline 312. The CC processor 318 is coupled to the CC circuitry 316. The CC processor 318 is configured to perform various operations, including: causing the TX pipeline 312 to transmit a first management packet over the network 306 to the receiver network device 304, the first management packet having a higher priority than other packets; receiving a first acknowledgement of the first management packet; determining, using the first acknowledgement, a first RTT representing a first physical delay between the sender network device 302 and receiver network device 304; determining an adjusted RTT by subtracting the first RTT from one or more RTTs measured between the sender network device 302 and receiver network device 304, the adjusted RTT representing a first congestion delay between the first network adapter and the second network adapter; adjusting, using the adjusted RTT, a first transmission rate of a first flow of packets to the receiver network device 304 to a second transmission rate; and causing the TX pipeline 312 to transmit subsequent packets, directed to the receiver network device 304, at the second transmission rate. In at least one embodiment, the second transmission rate is higher than the first transmission rate. In at least one embodiment, the second transmission rate is lower than the first transmission rate.

In a further embodiment, the CC processor 318 is further to perform operations including: causing the TX pipeline 312 to transmit a second management packet over the network 306 to a second receiver network device (i.e., a third network adapter), the second management packet having a higher priority than other packets; receiving a second acknowledgement of the second management packet; determining, using the second acknowledgement, a second RTT representing a second physical delay between the first network adapter and the third network adapter; determining a second adjusted RTT by subtracting the second RTT from one or more RTTs measured between the sender network device 302 and the second receiver network device, the second adjusted RTT representing a second congestion delay between the sender network device 302 and the second receiver network device; adjusting, using the second adjusted RTT, a third transmission rate of a second flow of packets to the second receiver network device to a fourth transmission rate; and causing the TX pipeline 312 to transmit subsequent packets, directed to the second receiver network device, at the fourth transmission rate.

In a further embodiment, the CC processor 318 is further to perform operations including: causing the TX pipeline 312 to transmit a second management packet over the network 306 to the receiver network device 304 the second management packet having a higher priority than other packets; receiving a second acknowledgement of the second management packet; determining, using the second acknowledgement, a second RTT representing the first physical delay between the sender network device 302 and the receiver network device 304; determining an average RTT using the first RTT and the second RTT; and determining the adjusted RTT by subtracting the average RTT instead of the first RTT from the one or more RTTs measured between the sender network device 302 and the receiver network device 304.

In a further embodiment, the CC processor 318 is further to perform operations including generating the first management packet.

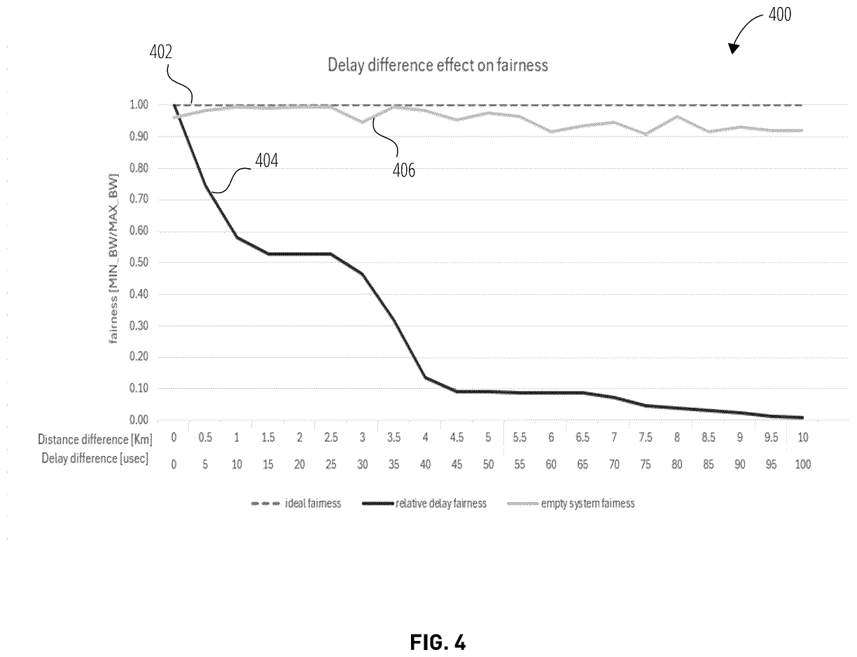

FIG. 4 is a graph 400 comparing an empty system RTT to relative delay according to at least one embodiment. The graph 400 include an ideal fairness level 402, a level of fairness using relative delay RTT 404, and a level of fairness using empty system RTT 406. As illustrated in graph 400, the level of fairness using empty system RTT 406 is closer to the ideal fairness level 402 than the level of fairness using relative delay RTT 404.

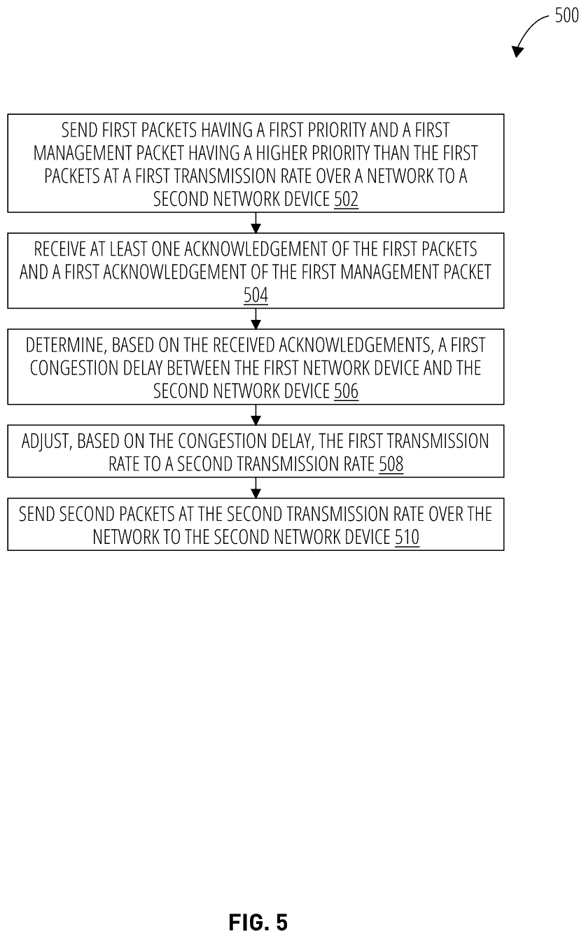

FIG. 5 is a flow diagram of a method 500 for adjusting transmission rate based on congestion delays without topology delays according to at least one embodiment. The method 500 can be performed by processing logic comprising hardware, software, firmware, or any combination thereof. In at least one embodiment, the method 500 is performed by any one of network device 100 of FIG. 1, far sender NIC 204, close sender NIC 206, or receiver NIC 208 of FIG. 2B, or sender network device 302 or receiver network device 304 of FIG. 3. In other embodiments, the method 500 can be performed by other devices as described herein.

Referring to FIG. 5, the method 500 begins with the processing logic sending first packets having a first priority and a first management packet having a higher priority than the first packets at a first transmission rate over a network to a second network device (block 502). At block 504, the processing logic receives at least one acknowledgement of the first packets and a first acknowledgement of the first management packet. At block 506, the processing logic determines, based on the received acknowledgements, a first congestion delay between the first network device and the second network device. At block 508, the processing logic adjusts, based on the congestion delay, the first transmission rate to a second transmission rate. In at least one embodiment, the second transmission rate is lower than the first transmission rate. In at least one embodiment, the wherein the second transmission rate is higher than the first transmission rate. At block 510, the processing logic sends second packets at the second transmission rate over the network to the second network device.

In a further embodiment, the first packets include a second management packet having the first priority. In a further embodiment, at block 506, the processing logic determines the first congestion delay by determining, based on at least the acknowledgement of the first management packet, a first delay representing a first physical delay between the first network device and the second network device. In at least one embodiment, the first delay is an RTT of the first management packet. The processing logic determines, based on the at least one acknowledgement of the one or more first packets, a second delay representing the first physical delay and a buffer congestion delay. In at least one embodiment, the second delay is an RTT of the second management packet. The processing logic subtracts the first delay from the second delay to obtain the first congestion delay. In at least one embodiment, one or more data packets can be sent between the first management packet and the second management packet.

In a further embodiment, the processing logic generates the first management packet (and the second management packet).

In at least one embodiment, the processing logic send third data packets having a third priority and a second management packet having a higher priority than the third priority at a third transmission rate over the network to a third network device. The processing logic receives at least one acknowledgement of the third packets and a second acknowledgement of the second management packet. The processing logic determines, based on the received acknowledgements, a second congestion delay between the first network device and the third network device. The processing logic adjusts, based on the second congestion delay, the third transmission rate to a fourth transmission rate. The processing logic sends fourth data packets at the fourth transmission rate over the network to the third network device.

In at least one embodiment, the processing logic sends a second management packet having the higher priority over the network to the second network device. The processing logic receives a second acknowledgement of the second management packet. The processing logic determines, based on at least the second acknowledgement, an updated congestion delay between the first network device and the second network device. The processing logic adjusts, based on the updated congestion delay, the second transmission rate to a third transmission rate. The processing logic sends third packets at the third transmission rate over the network to the second network device.

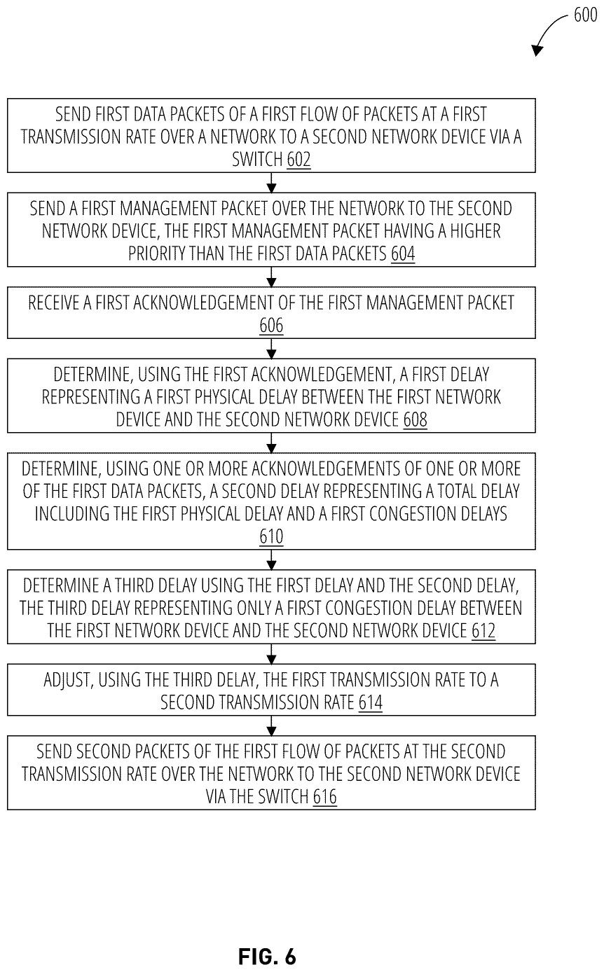

FIG. 6 is a flow diagram of a method 600 for adjusting a first transmission rate to a second transmission rate using a congestion delay according to at least one embodiment. The method 500 can be performed by processing logic comprising hardware, software, firmware, or any combination thereof. In at least one embodiment, the method 600 is performed by any one of network device 100 of FIG. 1, far sender NIC 204, close sender NIC 206, or receiver NIC 208 of FIG. 2B, or sender network device 302 or receiver network device 304 of FIG. 3. In other embodiments, the method 600 can be performed by other devices as described herein.

Referring to FIG. 6, the method 600 begins with the processing logic sending first data packets of a first flow of packets at a first transmission rate over a network to a second network device via a switch (block 602). At block 604, the processing logic sends a first management packet over the network to the second network device, the first management packet having a higher priority than the first data packets. At block 606, the processing logic receives a first acknowledgement of the first management packet. At block 608, the processing logic determines, using the first acknowledgement, a first delay representing a first physical delay between the first network device and the second network device. At block 610, the processing logic determines, using one or more acknowledgements of one or more of the first data packets, a second delay representing a total delay including the first physical delay and a first congestion delays. At block 612, the processing logic determines a third delay using the first delay and the second delay, the third delay representing only a first congestion delay between the first network device and the second network device. At block 614, the processing logic adjusts, using the third delay, the first transmission rate to a second transmission rate. At block 616, the processing logic sends second packets of the first flow of packets at the second transmission rate over the network to the second network device via the switch.

The processing logic can perform similar operations as described above with respect to FIG. 5.

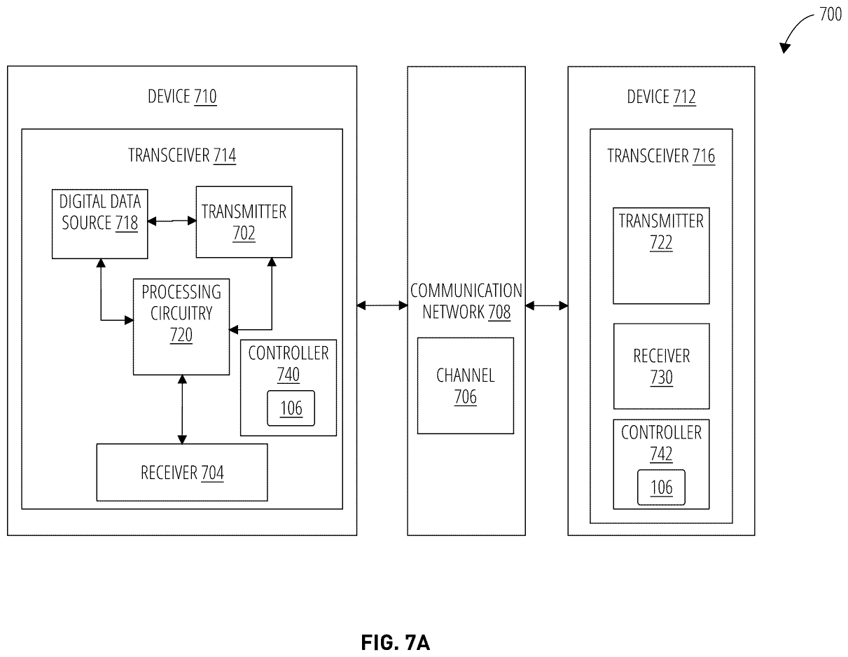

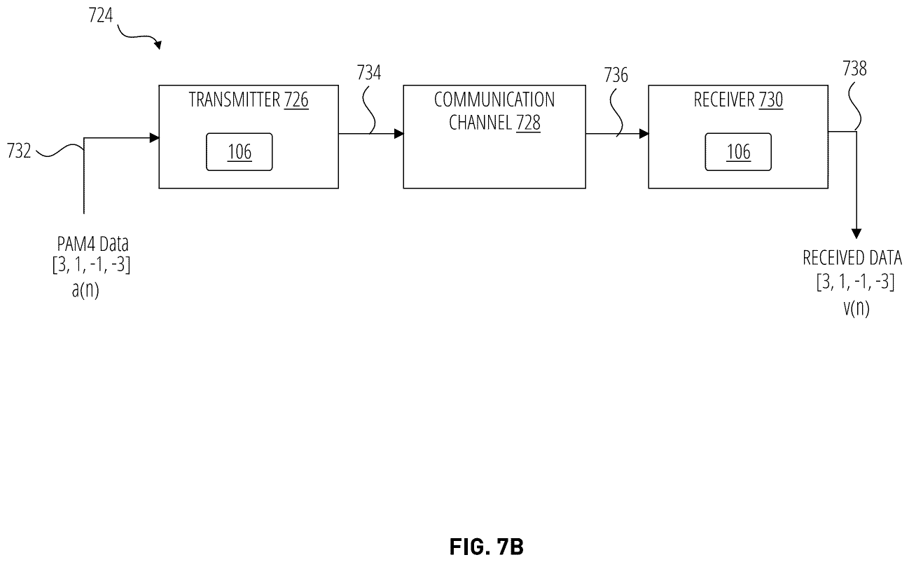

FIG. 7A illustrates an example communication system 700 with a controller 740 with topology-aware congestion control logic 106 according to at least one embodiment. The communication system 700 includes a device 710, a communication network 708 including a communication channel 706, and a device 712. In at least one embodiment, the devices 710 and 712 are integrated circuits of a Personal Computer (PC), a laptop, a tablet, a smartphone, a server, a collection of servers, or the like. In some embodiments, the devices 710 and 712 may correspond to any appropriate type of device that communicates with other devices also connected to a common type of communication network 708. According to embodiments, the transmitter 702 and 722 of devices 710 or 712 may correspond to transmitters of a Graphics Processing Unit (GPU), a switch (e.g., a high-speed network switch), a network adapter, a central processing unit (CPU), a data processing unit (DPU), etc.

Examples of the communication network 708 that may be used to connect the devices 710 and 712 include wires, conductive traces, bumps, terminals, optical fibers, or the like. In other embodiments, the communication network 708 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 708 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 708 is a network that enables data transmission between the devices 710 and 712 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller In at least one embodiment, a system for high-speed network communication includes a processing unit, a network interface comprising a receiver or transceiver with controller to optimize post-FEC BER performance of an FEC system using a post-FEC correlated performance metric, as described herein. The processing unit can include a CPU, a GPU, a DPU, a network adapter, a network switch, an NVLink switch, or the like. 2436, as described herein.

Other examples for the communication network 708 can include other chip-to-chip or die-to-die interconnects, such as GRS, LPI (low power interface) or LLI (low latency interface).

The device 710 includes a transceiver 714 for sending and receiving signals, for example, data signals. The data signals may be digital or optical signals modulated with data or other suitable signals for carrying data.

The transceiver 714 may include a digital data source 718, a transmitter 2402, a receiver 704, and processing circuitry 720 that controls the transceiver 714. The digital data source 718 may include suitable hardware and/or software for outputting data in a digital format (e.g., in binary code and/or thermometer code). The digital data output by the digital data source 718 may be retrieved from memory (not illustrated) or generated according to input (e.g., user input). The transceiver 714 can include the controller 740 with the topology-aware congestion control logic 106 as described above with respect to FIG. 1 to FIG. 6.

The transceiver 714 includes suitable software and/or hardware for receiving digital data from the digital data source 718 and outputting data signals according to the digital data for transmission over the communication network 708 to a transceiver 716 of device 712.

The receiver 704 of device 710 may include suitable hardware and/or software for receiving signals, for example, data signals from the communication network 708. For example, the receiver 704 may include components for receiving processing signals to extract the data for storing in a memory. In at least one embodiment, the transceiver 716 includes a transmitter 722 and receive 730. The transceiver 716 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC. The transceiver 716 can include a controller 742 with the topology-aware congestion control logic 106 as described above with respect to FIG. 1 to FIG. 6.

The processing circuitry 720 may comprise software, hardware, or a combination thereof. For example, the processing circuitry 720 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 720 may comprise hardware, such as an Application-Specific Integrated circuit (ASIC). Other non-limiting examples of the processing circuitry 720 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 720 may be provided on a Printed Circuit Board (PCB) or collection of PCBs. It should be appreciated that any appropriate type of electrical component or collection of electrical components may be suitable for inclusion in the processing circuitry 720. The processing circuitry 720 may send and/or receive signals to and/or from other elements of the transceiver 714 to control the overall operation of the transceiver 714.

The transceiver 714 or selected elements of the transceiver 714 may take the form of a pluggable card or controller for the device 710. For example, the transceiver 714 or selected elements of the transceiver 714 may be implemented on a network interface card (NIC).

The device 712 may include a transceiver 716 for sending and receiving signals, for example, data signals over a channel 706 of the communication network 708. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 714 may be applied to transceiver 716, and thus, the structure of transceiver 716 is not described separately.

Although not explicitly shown, it should be appreciated that devices 710 and 712 and the transceiver 714 and transceiver 716 may include other processing devices, storage devices, and/or communication interfaces generally associated with computing tasks, such as sending and receiving data.

FIG. 7B illustrates a block diagram of an example communication system 724 employing a topology-aware congestion control logic 106 in a transmitter 726 and a receiver 730 according to at least one embodiment.

In the example shown in FIG. 7B, a PAM level-4 (PAM4) modulation scheme is employed with respect to the transmission of a signal (e.g., digitally encoded data) from a transmitter (TX) transmitter 726 to a receiver (RX) signal 738 via a communication channel 728 (e.g., a transmission medium). In this example, the transmitter 726 receives input data 723 (i.e., the input data at time n is represented as “a(n)”), which is modulated in accordance with a modulation scheme (e.g., PAM4) and sends the signal 734, a(n), including a set of data symbols (e.g., symbols −3, −1, 1, 3, wherein the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM7, PAM8, PAM16, etc. For example, for an NRZ-based system, the transmitted data symbols consist of symbols-1 and 1, with each symbol value representing a binary bit. This is also known as a PAM level-2 or PAM2 system as there are 2 unique values of transmitted symbols. Typically, a binary bit 0 is encoded as −1, and a binary bit 1 is encoded as 1 as the PAM 2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 728 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 728 can be over serial links (e.g., a cable, printed circuit boards (PCBs) traces, copper cables, optical fibers, or the like), read channels for data storage (e.g., hard disk, flash solid-state drives (SSDs), high-speed serial links, deep space satellite communication channels, applications, or the like.

As described above, in some communication systems, the transmitter 726 sends the signal 734 as a data signal without a transmitter clock used to generate the data signal. The receiver (RX) 730 receives an incoming signal 736 over the communication channel 728. The incoming signal 736 can be degraded and attenuated by the communication channel 728 and include noise. The receiver 730 can output a received signal 738, “v(n),” including the set of data symbols (e.g., symbols −3, −1, 1, 3, wherein the symbols represent coded binary data). In at least one embodiment, the transmitter 726 can include the topology-aware congestion control logic 106 as described herein. In at least one embodiment, the receiver 730 can include the topology-aware congestion control logic 106 as described herein.

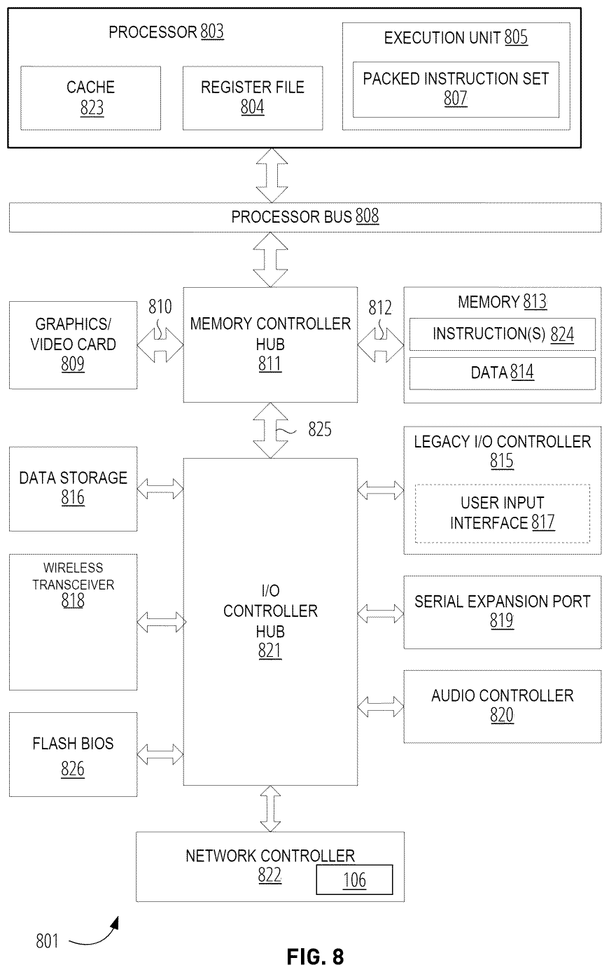

FIG. 8 illustrates an example computer system 801, including topology-aware congestion control logic 106, in accordance with at least some embodiments. In at least one embodiment, computer system 801 may be a system with interconnected devices and components, an SOC, or some combination. In at least one embodiment, computer system 801 is formed with a processor 803 that may include execution units to execute an instruction. In at least one embodiment, computer system 801 may include, without limitation, a component, such as a processor 803, to employ execution units including logic to perform algorithms for processing data. In at least one embodiment, computer system 801 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 801 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 801 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 801 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 801 may include, without limitation, processor 803 that may include, without limitation, one or more execution units 805 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 801 is a single processor desktop or server system. In at least one embodiment, computer system 801 may be a multiprocessor system. In at least one embodiment, processor 803 may include, without limitation, a CISC microprocessor, a RISC microprocessor, a VLIW microprocessor, and a processor implementing a combination of instruction sets, or any other processor device, such as a digital signal processor, for example. In at least one embodiment, processor 803 may be coupled to a processor bus 808 that may transmit data signals between processor 803 and other components in computer system 801.

In at least one embodiment, processor 803 may include, without limitation, a Level 1 (“L1”) internal cache memory (“cache”) 823. In at least one embodiment, processor 803 may have a single internal cache or multiple levels of internal cache. In at least one embodiment, cache memory may reside externally to processor 803. In at least one embodiment, processor 803 may also include a combination of both internal and external caches. In at least one embodiment, a register file 804 may store different types of data in various registers including, without limitation, integer registers, floating point registers, status registers, and instruction pointer register.

In at least one embodiment, execution unit 805, including, without limitation, logic to perform integer and floating point operations, also resides in processor 803. Processor 803 may also include a microcode (“ucode”) read only memory (“ROM”) that stores microcode for certain macro instructions. In at least one embodiment, execution unit 805 may include logic to handle a packed instruction set 807. In at least one embodiment, by including packed instruction set 807 in an instruction set of a general-purpose processor 803, along with associated circuitry to execute instructions, operations used by many multimedia applications may be performed using packed data in a general-purpose processor 803. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 806 may also be used in microcontrollers, embedded processors, graphics devices, DSPs, and other types of logic circuits. In at least one embodiment, computer system 801 may include, without limitation, a memory 813. In at least one embodiment, memory 813 may be implemented as a DRAM device, an SRAM device, flash memory device, or other memory devices. Memory 813 may store instruction(s) 824 and/or data 814 represented by data signals that may be executed by processor 803.

In at least one embodiment, a system logic chip may be coupled to a processor bus 808 and memory 813. In at least one embodiment, the system logic chip may include, without limitation, a memory controller hub (“MCH”) 811, and processor 803 may communicate with MCH 811 via processor bus 808. In at least one embodiment, MCH 811 may provide a high bandwidth memory path 812 to memory 813 for instruction and data storage and for storage of graphics commands, data, and textures. In at least one embodiment, MCH 811 may direct data signals between processor 803, memory 813, and other components in computer system 801 and may bridge data signals between processor bus 808, memory 813, and a system I/O 825. In at least one embodiment, a system logic chip may provide a graphics port for coupling to a graphics controller. In at least one embodiment, MCH 811 may be coupled to memory 813 through high bandwidth memory path 812, and graphics/video card 809 may be coupled to MCH 811 through an Accelerated Graphics Port (“AGP”) interconnect 810.

In at least one embodiment, computer system 801 may use system I/O 825 that is a proprietary hub interface bus to couple MCH 811 to I/O controller hub (“ICH”) 821. In at least one embodiment, ICH 821 may provide direct connections to some I/O devices via a local I/O bus. In at least one embodiment, a local I/O bus may include, without limitation, a high-speed I/O bus for connecting peripherals to memory 813, a chipset, and processor 803. Examples may include, without limitation, an audio controller 820, a firmware hub (“flash BIOS”) 726, a wireless transceiver 818, a data storage 816, a legacy I/O controller 815 containing a user input interface 817, a keyboard interface, a serial expansion port 819, such as a USB, and a network controller 822. In at least one embodiment, the network controller 822 includes the topology-aware congestion control logic 106 as described herein. Data storage 816 may comprise a hard disk drive, a floppy disk drive, a CD-ROM device, a flash memory device, or other mass storage device.

In at least one embodiment, FIG. 8 illustrates a system, which includes interconnected hardware devices or “chips.” In at least one embodiment, FIG. 8 may illustrate an example SoC. In at least one embodiment, devices illustrated in FIG. 8 may be interconnected with proprietary interconnects, standardized interconnects (e.g., PCIe), or some combination thereof. In at least one embodiment, one or more components of system 802 are interconnected using compute express link (“CXL”) interconnects.

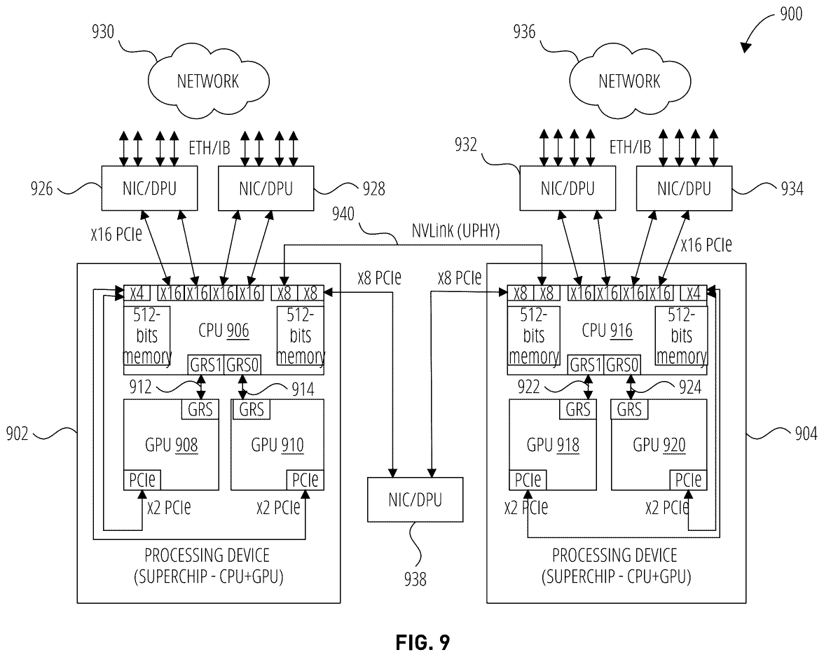

FIG. 9 is a block diagram of a computing system 900 having two processing devices coupled to each other and multiple networks according to at least one embodiment. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also be coupled to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also be coupled to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communicate with each other via a NIC/DPU 938, such as over PCIe interconnects. The processing device 902 and processing device 904 can also communicate with each other over a high-bandwidth communication interconnects 940, such as an NVLink interconnect or other high-speed interconnects. The NIC/DPUs of FIG. 9 can be the various embodiments of the DPUs described herein. The topology-aware congestion control logic 106 can be implemented in any transmitter or receiver device of any of the devices described herein.

In at least one embodiment, the computing system 900 is used for high-speed network communication and includes a processing unit (e.g., CPU 906, GPU 908, GPU 910, CPU 916, GPU 918, GPU 920, NIC/DPU 926, NIC/DPU 928, NIC/DPU 932, NIC/DPU 934, or NIC/DPU 938), and a network interface coupled to the processing unit. The network interface can include the operations and functionality of the topology-aware congestion control logic 106 described herein.

In at least one embodiment, a system for high-speed network communication includes a processing unit, and a network adapter coupled to the processing unit. The processing unit can include at least one of a central processing unit (CPU), a graphics processing unit (GPU), a deep learning accelerator, or an inference accelerator. The network adapter includes an RX pipeline, a TX pipeline, a CC circuitry, and a CC processor. The RX pipeline is configured to receive packets from a network and process the received packets. The network includes at least one switch between the network adapter and a second network adapter. The TX pipeline is configured to transmit packets to the network. The CC circuitry is coupled to the RX pipeline and TX pipeline, and the CC processor is coupled to the CC circuitry. The CC processor is to cause the TX pipeline to transmit a first management packet over the network to the second network adapter, the first management packet having a higher priority than other packets. The CC processor is to receive a first acknowledgement of the first management packet. The CC processor can determine, using the first acknowledgement, a first RTT representing a first physical delay between the network adapter and the second network adapter. The CC processor is to determine an adjusted RTT by subtracting the first RTT from one or more RTTs measured between the network adapter and the second network adapter, the adjusted RTT representing a first congestion delay between the network adapter and the second network adapter. The CC processor is to adjust, using the adjusted RTT, a first transmission rate of a first flow of packets to the second network adapter to a second transmission rate. The CC processor is to cause the TX pipeline to transmit subsequent packets, directed to the second network adapter, at the second transmission rate.

In at least one embodiment, the computing system 900 includes a host device and an auxiliary device. The auxiliary device includes a device memory and a processor, communicably coupled to the device memory. The auxiliary device performs the operations described herein with respect to FIG. 1 to FIG. 8. The auxiliary device can include a GPU. The auxiliary device can include a DPU. The auxiliary device can include a DPU. The auxiliary device can include accelerator hardware.

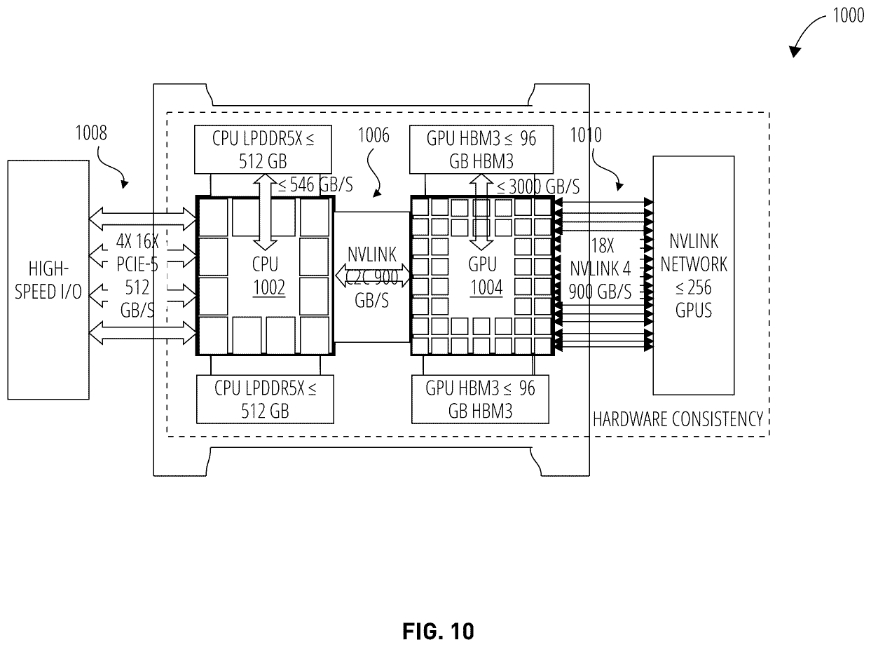

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

The computing system 1000 can include the topology-aware congestion control logic 106 used for the various embodiments described herein with respect to FIG. 1 to FIG. 9. The topology-aware congestion control logic 106 can be implemented in any of the devices described herein.

In at least one embodiment, the computing system 1000 is used for high-speed network communication and includes a processing unit, and a network interface coupled to the processing unit. The network interface can include the operations and functionality of the DPUs described herein.

In at least one embodiment, the computing system 1000 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

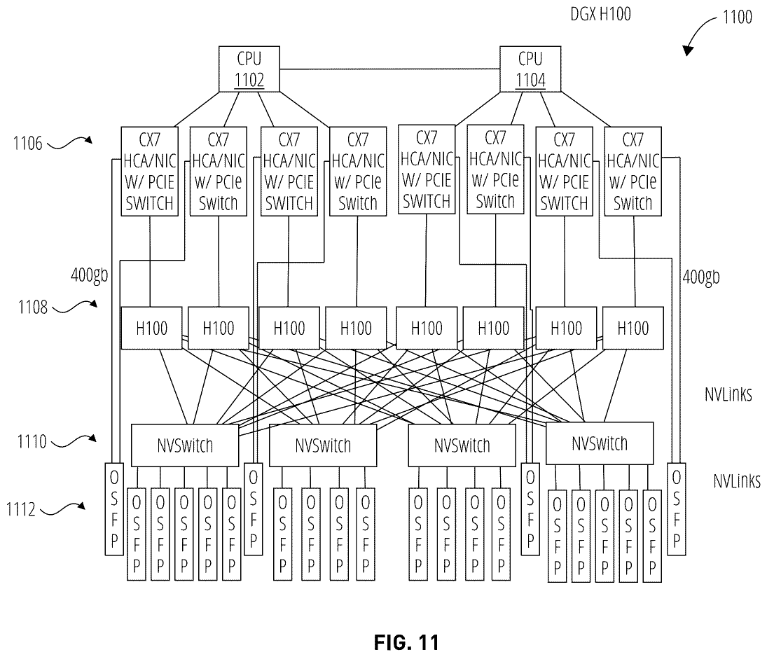

FIG. 11 is a block diagram of a computing system 1100 having tensor core GPUs 1108 according to at least one embodiment. The computing system 1100 can be a DGX H100 system, which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can each be one of the integrated circuits described above with respect to FIG. 10. The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1100 can include the topology-aware congestion control logic 106 as described in the various embodiments described herein with respect to FIG. 1 to FIG. 10.

In at least one embodiment, the computing system 1100 is used for high-speed network communication and includes a processing unit (e.g., CPU 1102, CPU 1104, switches 1106, tensor core GPUs 1108, switches 1110, high-speed transceiver modules 1112), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1100 includes a host device and an auxiliary device. The auxiliary device includes a device memory and a processor, communicably coupled to the device memory. The auxiliary device performs the operations described herein with respect to FIG. 1 to FIG. 10. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors-for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A first network device comprising:
a network interface to send one or more packets having a first priority and a management packet having a higher priority than the one or more packets at a first transmission rate over a network to a second network device; and
packet processing circuitry coupled to the network interface, the packet processing circuitry to:
receive at least one acknowledgement of the one or more packets and an acknowledgement of the management packet;
determine, based on the received acknowledgements, a congestion delay between the first network device and the second network device; and
adjust, based on at least the congestion delay, the first transmission rate to a second transmission rate, wherein the network interface is to send one or more additional packets at the second transmission rate over the network to the second network device.

2. The first network device of claim 1, wherein the packet processing circuitry is to determine the congestion delay by:
determining, based on at least the acknowledgement of the management packet, a first delay representing a first physical delay between the first network device and the second network device;
determining, based on the at least one acknowledgement of the one or more first packets, a second delay; and
subtracting the first delay from the second delay to obtain the congestion delay.

3. The first network device of claim 1, wherein the one or more packets having the first priority is a second management packet.

4. The first network device of claim 1, wherein the second transmission rate is lower than the first transmission rate.

5. The first network device of claim 1, wherein the packet processing circuitry is to generate the management packet.

6. The first network device of claim 2, wherein the first delay is a round-trip time (RTT) of the management packet.

7. The first network device of claim 1, wherein:
the network interface is to send one or more packets having the first priority and another management packet having the higher priority at a third transmission rate over the network to a third network device; and
the packet processing circuitry is to:
receive at least one acknowledgment of the one or more packets and an acknowledgment of the other management packet;
determine, based on the at received acknowledgements, a congestion delay between the first network device and the third network device; and
adjust, using the congestion delay between the first network device and the third network device, the third transmission rate to a fourth transmission rate, and wherein the network interface is to send one or more additional packet at the fourth transmission rate over the network to the third network device.

8. The first network device of claim 1, wherein the network interface is to send a second management packet over the network to the second network device, wherein the packet processing circuitry is further to:
receive at least one acknowledgement of the one more additional packets and an acknowledgement of the second management packet;
determine, based on the received acknowledgements, an updated congestion delay between the first network device and the second network device; and
adjust, based on at least the updated congestion delay, the second transmission rate to a third transmission rate, wherein the network interface is to send one or more additional packets at the third transmission rate over the network to the second network device.

9. A first network adapter comprising:
a receive (RX) pipeline, configured to receive packets from a network and process the received packets, the network comprising at least one switch between the first network adapter and a second network adapter;
a transmit (TX) pipeline, configured to transmit packets to the network;
congestion control (CC) circuitry coupled to the RX pipeline and TX pipeline; and
a CC processor coupled to the CC circuitry, wherein the CC processor is to:
cause the TX pipeline to transmit a first management packet over the network to the second network adapter, the first management packet having a higher priority than other packets;
receive a first acknowledgement of the first management packet;
determine, using the first acknowledgement, a first round-trip time (RTT) representing a first physical delay between the first network adapter and the second network adapter;
determine an adjusted RTT by subtracting the first RTT from one or more RTTs measured between the first network adapter and the second network adapter, the adjusted RTT representing a first congestion delay between the first network adapter and the second network adapter;
adjust, using the adjusted RTT, a first transmission rate of a first flow of packets to the second network adapter to a second transmission rate; and
cause the TX pipeline to transmit subsequent packets, directed to the second network adapter, at the second transmission rate.

10. The first network adapter of claim 9, wherein the second transmission rate is lower than the first transmission rate.

11. The first network adapter of claim 9, wherein the CC processor is further to:
cause the TX pipeline to transmit a second management packet over the network to a third network adapter, the second management packet having a higher priority than other packets;
receive a second acknowledgement of the second management packet;
determine, using the second acknowledgement, a second RTT representing a second physical delay between the first network adapter and the third network adapter;
determine a second adjusted RTT by subtracting the second RTT from one or more RTTs measured between the first network adapter and the third network adapter, the second adjusted RTT representing a second congestion delay between the first network adapter and the third network adapter;
adjust, using the second adjusted RTT, a third transmission rate of a second flow of packets to the third network adapter to a fourth transmission rate; and
cause the TX pipeline to transmit subsequent packets, directed to the third network adapter, at the fourth transmission rate.

12. The first network adapter of claim 9, wherein the CC processor is further to:
cause the TX pipeline to transmit a second management packet over the network to the second network adapter, the second management packet having a higher priority than other packets;
receive a second acknowledgement of the second management packet;
determine, using the second acknowledgement, a second RTT representing the first physical delay between the first network adapter and the second network adapter;
determine an average RTT using the first RTT and the second RTT; and
determine the adjusted RTT by subtracting the average RTT instead of the first RTT from the one or more RTTs measured between the first network adapter and the second network adapter.

13. The first network adapter of claim 9, wherein the CC processor is further to generate the first management packet.

14. A method of operating a first network device, the method comprising:
sending first packets having a first priority and a first management packet having a higher priority than the first packets at a first transmission rate over a network to a second network device;
receiving at least one acknowledgement of the first packets and a first acknowledgement of the first management packet;
determining, based on the received acknowledgements, a first congestion delay between the first network device and the second network device;
adjusting, based on the first congestion delay, the first transmission rate to a second transmission rate; and
sending second packets at the second transmission rate over the network to the second network device.

15. The method of claim 14, wherein the first packets comprises a second management packet having the first priority.

16. The method of claim 14, wherein determining the first congestion delay comprises:
determining, based on at least the acknowledgement of the first management packet, a first delay representing a first physical delay between the first network device and the second network device;
determine, based on the at least one acknowledgement of the first packets, a second delay; and
subtracting the first delay from the second delay to obtain the first congestion delay.

17. The method of claim 14, wherein the second transmission rate is lower than the first transmission rate.

18. The method of claim 14, further comprising generating the first management packet.

19. The method of claim 16, wherein the first delay is a round-trip time (RTT) of the first management packet.

20. The method of claim 14, further comprising:
sending third data packets having a third priority and a second management packet having a higher priority than the third priority at a third transmission rate over the network to a third network device;
receiving at least one acknowledgement of the third packets and a second acknowledgement of the second management packet;
determining, based on the received acknowledgements, a second congestion delay between the first network device and the third network device;
adjusting, based on the second congestion delay, the third transmission rate to a fourth transmission rate; and
sending fourth data packets at the fourth transmission rate over the network to the third network device.

21. The method of claim 14, further comprising:
sending a second management packet having the higher priority over the network to the second network device;
receiving a second acknowledgement of the second management packet;
determining, based on at least the second acknowledgement, an updated congestion delay between the first network device and the second network device;
adjusting, based on the updated congestion delay, the second transmission rate to a third transmission rate; and
sending third packets at the third transmission rate over the network to the second network device.

22. A system for high-speed network communication, the system comprising:
a processing unit; and
a network adapter coupled to the processing unit, wherein the network adapter comprises:
a receive (RX) pipeline, configured to receive packets from a network and process the received packets, the network comprising at least one switch between the network adapter and a second network adapter;
a transmit (TX) pipeline, configured to transmit packets to the network;
congestion control (CC) circuitry coupled to the RX pipeline and TX pipeline; and
a CC processor coupled to the CC circuitry, wherein the CC processor is to:
cause the TX pipeline to transmit a first management packet over the network to the second network adapter, the first management packet having a higher priority than other packets;
receive a first acknowledgement of the first management packet;
determine, using the first acknowledgement, a first round-trip time (RTT) representing a first physical delay between the network adapter and the second network adapter;
determine an adjusted RTT by subtracting the first RTT from one or more RTTs measured between the network adapter and the second network adapter, the adjusted RTT representing a first congestion delay between the network adapter and the second network adapter;
adjust, using the adjusted RTT, a first transmission rate of a first flow of packets to the second network adapter to a second transmission rate; and
cause the TX pipeline to transmit subsequent packets, directed to the second network adapter, at the second transmission rate.

23. The system of claim 22, wherein the processing unit comprises at least one of a central processing unit (CPU), a graphics processing unit (GPU), a deep learning accelerator, or an inference accelerator.
